(19) United States
(12) Patent Application Publication
(10) Pub. No.: US 2006/0102564 A1
(43) Pub. Date: May 18, 2006

(54) SYSTEM OF SLUDGE DEWATERING AND METHOD FOR FILTER CLOTH AUTOMATIC WASHING OF FILTER PRESS MACHINE

(76) Inventors: Chen-Chung Huang, Hsinchu (TW); Kun-Sen Sung, Miaoli (TW); Hung-Yuan Chen, Kaohsiung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,082

(22) Filed: Jul. 22, 2005

(30) Foreign Application Priority Data
Nov. 16, 2004 (TW) 93135045

(51) Int. Cl. C02F 1/00

(52) U.S. Cl. 210/769

(57) ABSTRACT

A system of sludge dewatering is described. The system comprises of a filter press, a sludge fee pipe, and acid feed pipe, and exhaust pipe and a discharge pipe. The sludge feed pipe is configured on the filter press. The acid feed pipe is connected with the sludge feed pipe. The exhaust pipe is connected with the sludge feed pipe. The discharge pipe is configured on the filter press. The system of the present invention can lead the acid solution into the filter press by the acid feed pipe so as to use in situ way to proceed filter cloth washing of the filter press.

### CROSS-REFERENCE TO RELATED APPLICATION

This application claims the priority benefit of Taiwan application serial no. 93135045, filed on Nov. 16, 2004. All disclosure of the Taiwan application is incorporated herein by reference.

### BACKGROUND OF THE INVENTION

1. Field of the Invention

The present invention generally relates to a method for cleaning filter cloth of a sludge dewatering machine. More particularly, the present invention relates to a sludge dewatering system for cleaning filter cloth in-situ and automatically cleaning method for the filter cloth of filter press machine.

2. Description of Related Art

As the fast development in industries, the waste water from the industry and the family are increasing drastically which cause more problems in handling the waste water. Besides, the sludge in the water is possibly to cause the second damage to the environment if the handling is not appropriate. In order to process the sludge in the waste water under an economic and efficient scale, reducing the moisture and solidification for the sludge are required before the transportation, burning or burying underground. Therefore the dewatering process becomes the most important step to reduce the volume of the sludge.

The most common used sludge dewatering equipment is the Filter Press Machine, where the advantages are the abilities to handle the sludge with high moisture under high filtering speed and can be applied to handle the chemical wastes.

As is well known in the art, the process to handle he sludge starts from applying a hydraulic press to compress the filters and form the filter rooms, then high pressure pump is applied to suck the sludge from the store to the filter rooms, till the rooms are full. Then the difference of the pressure from the filter and filter cloth inside the filter room can expel the moisture from the sludge and result in the residue of the dry sludge. Finally the hydraulic press releases the filters and separates the dry sludge, then the dry sludge comes off.

In addition, in order to maintain the function of the press filter dewatering machine and reduce the moisture together with the cost for the delivering of the waste, normally, high pressure water to clean the cloth is required to complete the operation cycle.

However, there are still some problems existed. For example, after a certain period of usage, the hole on the filter cloth of the filter press sludge dewatering machine can be seriously blocked or even can not let go of moisture, therefore machine can not function properly. Sometimes, even high pressure water is unable to clean the filter cloth. Till this stage, the filter cloth has to be unloaded for the acid washing process before they can be re-used again. As is well known in the art, the acid washing process comprises the unloading the filter cloth, primary cleaning the dirt by water, then immersed at 5% hydrochloric acid solution for at least 3 days to dissolved the blocking material through the hydrochloric acid by the excellence in the ability of dissolution, and finally washed by clean water before they are dried and loaded back to the machine.

In view of the above mentioned descriptions, the prior art for the acid washing process comprises complicated steps, not only time consuming but also with enormous cost and high demands for manpower. In addition, while the filter cloth is unloaded for acid washing process, the filter press sludge dewatering machine is under no performance which will affect the management for the efficiency.

### SUMMARY OF THE INVENTION

Broadly speaking, the present invention enables a sludge dewatering system to reduce the time and manpower for cleaning the filter cloth and improve the management of the efficiency for the sludge dewatering machine.

Accordingly, the present invention is directed to an automatic cleaning method for the filter press sludge dewatering machine to resolve the problems happened on the prior art regarding the time consuming and labor demanding process in cleaning/washing, and try to shorten the timeframe for filter cloth cleaning and save the labor cost.

In accordance with one aspect of the present invention, a sludge dewatering system is claimed and the system comprises a filter press sludge dewatering machine, a sludge feed pipe, an acid feed pipe, an exhaust pipe, and a discharge pipe. Where the sludge feed pipe is disposed on the filter press sludge dewatering machine, the acid feed pipe is connected with the sludge feed pipe, the discharge pipe is also connected to the sludge feed pipe. In addition, the discharge pipe is disposed on the filter press sludge dewatering machine. Where the acid is through the acid feed pipe into the filter press sludge dewatering machine, and washes the filter cloth by in situ cleaning filter press sludge dewatering machine.

According to a preferred embodiment of the sludge dewatering system for the present invention, the filter press sludge dewatering machine comprises a body, a few filters, a few filter cloth and a hydraulic press. Where the body is with at least two horizontal bars; the filters can cross those horizontal bars, and the filters in the neighborhood closed to form the filter rooms. In addition, the mentioned filter cloth covers the filters; and the hydraulic press is located at one side of the body. The hydraulic press comprises a moving terminal and a fixed terminal, which are connected to those horizontal bars of the body with the functions to close or separate the filters.

According to a preferred embodiment of the sludge dewatering system for the present invention, there is a first control valve disposed on the sludge feed pipe. In addition, the preferred embodiment for the present invention of the sludge dewatering system further comprises a backflow pipe which is disposed on the sludge feed pipe and a second valve is disposed on the back flow pipe.

According to a preferred embodiment of the sludge dewatering system for the present invention, the system further comprises a clean pipe which is disposed on the filter press sludge dewatering machine and a control valve is disposed on the clean pipe.

According to a preferred embodiment of the sludge dewatering system for the present invention, a first control valve is disposed on the acid feed pipe. In addition, the system further comprises a tape water feed pipe which is connected to the acid feed pipe, and there is a second control valve disposed on the tape water feed pipe.

According to a preferred embodiment of the sludge dewatering system for the present invention, a control valve is disposed on the exhaust pipe.

According to a preferred embodiment of the sludge dewatering system for the present invention, a control valve is disposed on the discharge pipe.

According to a preferred embodiment of the sludge dewatering system for the present invention, the system further comprises branch pipe and there is a control valve disposed on the branch pipe.

In accordance with one aspect of the present invention, the acid feed pipe is used to introduce acid to the filter press sludge dewatering machine for cleaning the filter cloth. Therefore, the invention can reduce the required time and labor, and improve the efficiency in the management.

In accordance with another aspect of the present invention, an automatic cleaning method for the filter cloth of the filter press sludge dewatering machine is claimed, comprising closing the filters in the neighborhood to form the filter rooms and covering the filter with filter cloth, then introduction the acid into the filter rooms for a period of time to wash the cloth, and finally draining out the acid.

According to the preferred embodiment of the present invention, the acid is delivered through the connection between the acid feed pipe and the filter press sludge dewatering machine, then introduced into the filter room. In addition, the exhaust pipe is further connected with the filter press sludge dewatering machine to release the gas generated by the acid.

According to the preferred embodiment of the present invention, the method for automobile cleaning the filter cloth of the filter press sludge dewatering machine further comprises to connect the discharge pipe with the system of the filter press sludge dewatering, therefore the used acid can be drain out.

According to the preferred embodiment of the present invention, after draining out the used acid, the step is further followed by feeding tape water into the filter room to clean the filter cloth inside the filter room. In addition, the method to feed taper water inside the filter room is to design the tape water pipe into the filter room. Besides, after feeding the tape water into the filter room, the step is followed by draining out the tape water.

According to the preferred embodiment of the present invention, the acid used in the automobile cleaning method is hydrochloride acid.

According to the preferred embodiment of the present invention, the period of time for acid to be retained is twenty four hours.

In conclusion of the above description, the automatic cleaning method for the filter cloth is an in situ washing process to clean the filter cloth, which can resolve the problems happened in the prior art, which is the filter press sludge dewatering machine, and known to be time consuming and labor demanding.

It is to be understood that the foregoing general description and the following detailed description are exemplary and explanatory only and are not restrictive of the invention, as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates the elements allocation for the system of the sludge dewatering according to one preferred embodiment of the present invention.

FIG. 2 illustrates the flow chart for the automobile cleaning method of the filter cloth in the filter press sludge dewatering machine according to one preferred embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The sludge dewatering system and the automatic cleaning method for the filter cloth of the filter press sludge dewatering machine of the present invention can be applied to the semiconductor factory and photo-electronic factory . . . etc, and related high-tech industry during their processes to manage waste water. In addition, other industries like chemical engineering, petroleum, pharmaceuticals, textiles and food industries can also apply the present invention to handle their waste water during their processes.

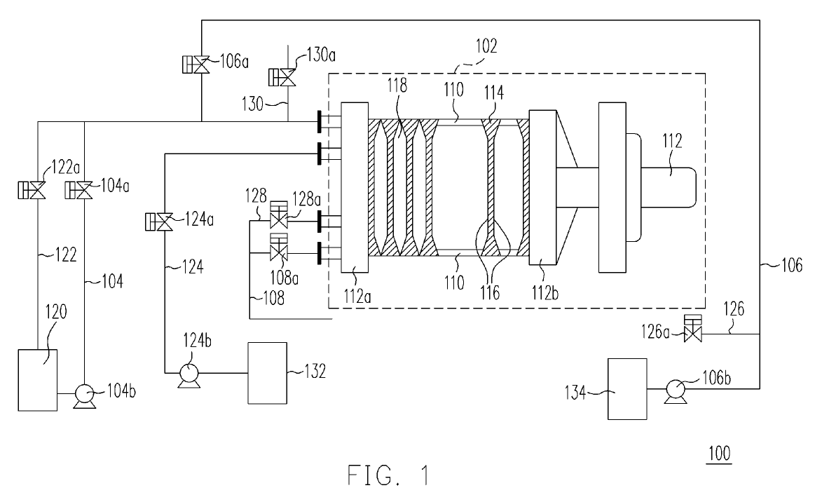

FIG. 1 illustrates the elements allocation for the system of the sludge dewatering according to one preferred embodiment of the present invention.

Please refer to the FIG. 1, the sludge dewatering system 100 of the present invention comprises the filter press sludge dewatering machine 102, sludge feed pipe 104, acid feed pipe 106, exhaust pipe 130 and discharge pipe 108.

However, the above mentioned sludge dewatering machine 102 comprises a body, a hydraulic press 112, a few filters 114, a few filter cloth 116. The body is with two horizontal bars 110. The hydraulic press 112 is disposed on one side of the body and further comprises a moving terminal 112a and a fixed terminal 112b, which are connected to those horizontal bars 110 of the body to close or separate the filters 114. In addition, the filters 114 can cross those horizontal bars 110 and the filter cloth 116 covers the filters 114. As mentioned, the filters 114 are movable filters and can be adjusted by the hydraulic press 112 to adjust the moving terminal 112a towards the fixed terminal 112a, therefore the filters in the neighborhood 114 can form a close space to be the filter rooms 118 in order to remove the moisture away from the sludge.

In addition, the above mentioned sludge feed pipe 104 is disposed on the filter press sludge dewatering machine 102 and there is a control valve 104a disposed on the sludge feed pipe 104. Besides, the waste water can be sucked by the pump 104b from the sludge store 120 through the sludge feed pipe 104 into the filter press sludge dewatering machine 102. In addition, the sludge feed pipe 104 can be connected to the back flow pipe 122, and there is a control valve 122a disposed on the back flow pipe 122, furthermore one terminal of back flow pipe 122 is connected to the sludge store 120. The previous mentioned back flow pipe 122 can avoid the overflow of the waste water during the transportation through filter rooms 118 to the filter press sludge dewatering machine 102 and further flow back to the sludge store 120.

As mentioned previously, the clean pipe 124 and the filter press sludge dewatering machine 102 can be disposed on the sludge dewatering system 100, and a control valve 124a is disposed on the clean pipe 124. The mentioned clean pipe 124 can be used for normal clean filter press sludge dewatering machine 102 and the cleaning task is undertaken by the high pressure pump 124b to transport the clean solution from the clean solution store 132 towards the filter pressure sludge dewatering machine 102.

Besides, one terminal of the acid feed pipe 106 in the present invention is disposed at the entrance of the sludge feed pipe 104 while the other terminal is connected to the pump 106b, and there is a control valve 106a disposed on the acid feed pipe 106. The acid feed pipe 106 can introduce acid from the acid store 134 towards the filter pressure sludge dewatering machine 102 to dissolve the blocking material inside the hole of the filter cloth 116 in order to clean the filter cloth. As there will be chemical vapor or gas generated by the acid, therefore, the exhaust pipe 130 is required to be connected to the entrance of sludge feed pipe 104 and there is a control valve 130a disposed on the exhaust pipe. Of course, the tape water pipe 126 can be disposed on the way of the acid feed pipe 106, together with a control valve 126a disposed on the tape water pipe 126. Therefore, after the acid cleaning of the filter cloth 116 of the filter press sludge dewatering machine 102, the filter cloth 116 can be further cleaned by the tape water to wash out the acid in the filter rooms 118.

Besides, the above mentioned discharge pipe 108 is disposed on the filter press sludge dewatering machine 102, and there is a control valve 108a disposed on the discharge pipe 108. In addition, a branch pipe 128 can be disposed on the discharge pipe 108 with a control valve 128a. Where the discharge pipe 108 and the branch pipe 128 can drain out the moisture form the sludge, clean solution, acid and tape water, while the control valve 108a and the control valve 128a can be used to avoid the overflow of the acid inside the filter rooms 118 during the cleaning process for filter cloth 116 and allowing the blocking dissolved by the acid from the hole on the filter cloth 116.

The following is the explanation to describe the automatic cleaning method for the filter cloth of the filter press sludge dewatering machine after the moisture is removed from the sludge.

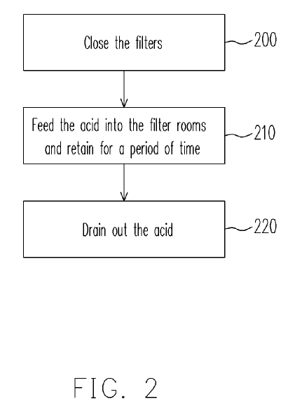

FIG. 2 illustrates the flow chart for the automobile cleaning method of the filter cloth in the filter press sludge dewatering machine according to one preferred embodiment of the present invention.

Referring to FIG. 1 and FIG. 2, the filter 114 is closed (step 200) to enable the filter rooms 118 formed by filters 114 in the neighbourhood. The closing power is from the hydraulic press 112 to push the moving terminal 112b forwards the fixed terminal 112a to enable a few filters 114 on the filter press sludge dewatering machine 102 to be closed. As shown in the FIG. 1, the filter 114 is covered with filter cloth 116 and the filters 114 in the neighbourhood will form a filter room 118.

Then, the acid is filled into filter room 118 and the acid is retained for a certain period of time (step 210) to dissolve the blocking out of the hole on the filter cloth 116 for cleaning the filter cloth 114. As mentioned above, the acid can be hydrochloric acid and the method for delivering acid into the filter room 118 is through the acid feed pipe 106 and allow the acid to stay for twenty four hours in the filter room 118.

In addition, before the acid is delivered to the filter room 118, the control valve 104a, control valve 108a, control valve 122a, control valve 124a, control valve 128a have to be closed and formed a closed space as filter room 118 to be filled in the acid. Then, control valve 130a is opened to avoid the chemical vapor generated by the acid to create pressure in the filter room 118 and impact the whole system. Thereafter, the pump 106b is opened to feed the acid into the filter room 118 till the room is full. While there is acid flowing from the control valve 130a, it is the sign that the filter room 118 is filled, the control valve 106a and the pump 106b are then closed. At this stage, the control valve 103a has to be maintained opened and continued to release the chemical vapor or gas from the exhaust pipe 130.

Please continuing refer FIG. 1 and FIG. 2, acid is drained out (step 220) after the above mentioned steps. The method to drain out the acid is to open the control valve 108a and control valve 128a to release the acid through discharge pipe 108.

Besides, after the step 220, tape water can be filled into the filter rooms 118 to clean the filter room 118 and filter cloth 116. Where the method to fill the tape water into the filter room 118 is to close the control valve 108a and control valve 128a, then pass the tape water through the tape water pipe 126 into the filter room 118. Furthermore, the control valve 108a and control valve 128a can be opened to release the tape water from discharge pipe 108.

After the above mentioned steps, the whole processes are completed. After reset those control valves, the filter press sludge dewatering machine can be restart the sludge dewatering process again.

In conclusion of the present invention, the acid pipe 106 is disposed on the sludge dewatering system 100, and introduce the acid into the filter rooms 118 to clean the filter cloth 106. There is no need to unload the filter cloth for a series of cleaning processes as prior art did, therefore, the savings from the labour cost and time shortening are significant to contribute on the cost of production. Besides, the above mentioned automatically cleaning method can apply in situ to clean the filter cloth to save the cleaning time and improve the efficiency in the management of the filter press sludge dewatering machine.

The foregoing descriptions of specific embodiments and comparison for the present invention have been presented for purposes of illustration and description. They are not intended to be exhaustive or to limit the invention to the precise forms disclosed. Obviously, many modifications and variations are possible in light of the above teaching. The embodiments were chosen and described in order to explain the principles and the application of the invention, thereby enabling others skilled in the art to utilize the invention in its various embodiments and modifications according to the particular purpose contemplated. The scope of the invention is intended to be defined by the claims appended hereto and their equivalents.

### EMBODIMENT

The automatic cleaning method for the filter cloth of the filter press sludge dewatering machine is to close the filter, then feeding the acid into the filter room and retaining the acid for twenty four hours. Thereafter, the acid is drain out to complete the filter cloth cleaning process. In addition, it is allowable to wash the filter room for two to three times by tape water for washing out the acid.

The above mentioned processes required only one engineer to spend about thirty six hours working hours independently.

Comparison Case:

The method used in the prior art is to unload the filter cloth which will take about 4 hours with 4 manpower. Then the next step to process the primary cleaning by the tape water is estimated to take one working hours with two manpower. The following step to dissolve 5% of hydrochloric acid into a bucket and drench the filter cloth is estimated to take one working hours with two manpower. After seven two hours, the filter cloth is removed and clean by mass amount of water, this step will take about one working hours with two manpower. Thereafter, the filter cloth is naturally dried for twelve hours. Finally, four people may spend four hours to load the filter cloth back to the filter press sludge dewatering machine.

In conclusion of above mentioned processes, the prior art requires many people to spend about six days for the filter cloth cleaning process.

Therefore, in comparison between the embodiment and the comparison case, the prior art requires a series of complicated processes which demands huge amount of manpower and time. However, the present invention of the automatic cleaning method for the filter cloth requires only one engineer working independently, and the required working hours are largely reduced. In addition, the present invention improve the efficiency in the management of the filter press sludge dewatering machine by largely reduce the time spent on the filter cloth cleaning.

In conclusion, the present invention provides the following advantages:

1. The present invention reduces the time spending on the filter cloth cleaning and save the manpower cost for cleaning the filter cloth.

2. The present invention reduce the required time and manpower in cleaning the filter cloth, therefore, the efficiency for the management of the filter press sludge dewatering machine is improved.

3. The present invention can be applied to the semiconductor factory, photo-electronic factory, and related high-tech industry to process their waste water, in addition, application in appropriate fields like chemical engineering, petroleum, pharmaceuticals, textiles and food industries are all acceptable.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system of sludge dewatering, comprising:
a filter press sludge dewatering machine;
a sludge feeding pipe, configured on the filter press sludge dewatering machine;
an acid feeding pipe, connected with the sludge feeding pipe;
an exhaust pipe, connected with the sludge feeding pipe; and
a discharge pipe, configured on the filter press sludge dewatering machine, wherein
the acid feeding pipe leads an acid into the filter press sludge dewatering machine to in situ wash a plurality of filter cloth inside the filter press sludge dewatering machine.

2. The system of sludge dewatering according to claim 1, wherein the filter press sludge dewatering machine comprises:
a body, having at least two horizontal bars;
a plurality of filters, wherein the filters are disposed across those horizontal bars, and two adjacent filters form a filter room;
a plurality of filter cloth, covering the filters; and
a hydraulic press, located at one side of the body.

3. The system of sludge dewatering according to claim 2, wherein the hydraulic press comprises a moving terminal and a fixed terminal, and both the moving terminal and the fixed terminal connected to the horizontal bars of the body to enable the closing or separating of the filters.

4. The system of sludge dewatering according to claim 1, wherein a first control valve is disposed on the sludge feeding pipe.

5. The system of sludge dewatering according to claim 4, further comprising a back flow pipe disposed on the sludge feeding pipe and a second valve disposed on the back flow pipe.

6. The system of sludge dewatering according to claim 1, further comprising a cleaning pipe disposed on the filter press sludge dewatering machine and a control valve disposed on the cleaning pipe.

7. The system of sludge dewatering according to claim 1, wherein a first control valve is disposed on the acid feeding pipe.

8. The system of sludge dewatering according to claim 7, wherein the system further comprises a tape water feeding pipe connected to the acid feeding pipe, and a second control valve disposed on the tape water feeding pipe.

9. The system of sludge dewatering according to claim 1, wherein a control valve is disposed on the exhaust pipe.

10. The system of sludge dewatering according to claim 1, wherein a control valve is disposed on the discharge pipe.

11. The system of sludge dewatering according to claim 1, further comprising a branch pipe and a control valve disposed on the branch pipe.

12. An automobile cleaning method for the filter cloth of the filter press sludge dewatering machine, comprising:
closing a plurality of filters to form a plurality of filter rooms between the adjacent filters, wherein the filters are covered by a plurality of filter cloth;
feeding the acid into the filter rooms and retaining the acid for a period of time, wherein the acid is used to clean the filter cloth; and
draining out the acid.

13. The automobile cleaning method for the filter cloth of the filter press sludge dewatering machine according to claim 12, wherein the step of feeding the acid into the filter rooms further comprises to connect the acid feeding pipe with the system of the filter press sludge dewatering, therefore the acid is lead to the filter room.

14. The automobile cleaning method for the filter cloth of the filter press sludge dewatering machine according to claim 13, wherein the step of feeding the acid into the filter rooms further comprises an exhaust pipe to connect the system of the filter press sludge dewatering in order to drain out the gas generated by the acid.

15. The automobile cleaning method for the filter cloth of the filter press sludge dewatering machine according to claim 12, wherein the step of draining out the acid further comprises a discharge pipe connected to the system of the filter press sludge dewatering, for draining out the used acid.

16. The automobile cleaning method for the filter cloth of the filter press sludge dewatering machine according to claim 12, after draining out the used acid, wherein a tape water is filled into the filter rooms for cleaning the filter cloths.

17. The automobile cleaning method for the filter cloth of the filter press sludge dewatering machine according to claim 16, wherein the step of feeding the tape water into the filter rooms, further comprising a tape water pipe connected to the filter rooms.

18. The automobile cleaning method for the filter cloth of the filter press sludge dewatering machine according to claim 16, after the step of feeding the tape water into the filter rooms, further comprising a step of draining out the used water.

19. The automobile cleaning method for the filter cloth of the filter press sludge dewatering machine according to claim 12, wherein the acid solution is including a hydrochloride acid solution.

20. The automobile cleaning method for the filter cloth of the filter press sludge dewatering machine according to claim 12, wherein the acid solution is retained for twenty-four hours.
